(19) United States
(12) Patent Application Publication
(10) Pub. No.: US 2014/0277984 A1
(43) Pub. Date: Sep. 18, 2014

(54) COORDINATED BRAKE CONTROL OF WHEELS ON A COMMON DIFFERENTIAL

(71) Applicant: FORD GLOBAL TECHNOLOGIES, LLC, Dearborn, MI (US)

(72) Inventors: Gregory Michael Pietron, Canton, MI (US); Lawrence M. Rose, Berkley, MI (US); Jason Meyer, Novi, MI (US); Kerem Bayar, Dearborn, MI (US)

(73) Assignee: Ford Global Technologies, LLC, Dearborn, MI (US)

(21) Appl. No.: 13/800,513

(22) Filed: Mar. 13, 2013

(51) Int. Cl. B60T 8/1761

(52) U.S. Cl. CPC B60T 8/1761; Y10S 903/947
USPC 701/78; 903/947; 180/65.27

(57) ABSTRACT

A hybrid vehicle includes an internal combustion engine and an electric motor for powering two wheels. The wheels are separated by a common differential. A controller is provided to execute certain commands related to the braking of the vehicle. During braking of the two wheels, one wheel exceeds its slip limit, causing the wheel speed of that wheel to drop and pull-down as the wheel catches the ground. In response to the one wheel pulling-down, the controller commands a reduction of brake actuation force on the pulled-down wheel, and also commands a reduction of a rate of increase of the brake actuation force on the non-pulled-down wheel. Simultaneous pull-down or pull-up of the wheels is thereby inhibited as brake actuation forces on each wheel are continued to be controlled in response to the other wheel's activity.

### TECHNICAL FIELD

The present disclosure relates to a vehicle and a control system for controlling the vehicle. More specifically, the present disclosure relates to controlling a braking system in a vehicle.

### BACKGROUND

Antilock brake systems (ABS) are known in the art to prevent wheels from locking up. During a braking event in a vehicle implementing ABS, if the vehicle detects one wheel rotating significantly slower than the other wheels, brake pressure at that wheel is reduced to allow that wheel to spin faster.

Hybrid electric vehicles (HEVs) include an internal combustion engine and a traction motor to provide power to propel the vehicle. Battery electric vehicles (BEVs) do not include an internal combustion engine, and rather include a large electric power source such as a high voltage traction battery to power a traction motor to provide power to propel the vehicle. In both HEVs and BEVs, a pair of wheels are connected along a drive axle and torque is distributed from the traction motor via a differential. During a braking event in a HEV vehicle with ABS, wheel speed fluctuations across the common differential may occur due to the brake pressure in the wheels increasing and decreasing in response to the wheel speed at which the brake is applied. Fluctuating speed and torque can wind and unwind portions of the drive axle; the effects of the speed and torque fluctuations can compound over time, especially if the fluctuations align in direction. The traction motor provides a source of relatively large effective inertia through a gear set to the differential that partially (but not entirely) resists these wheel speed fluctuations.

### SUMMARY

According to at least one embodiment, a vehicle includes a differential, two shafts extending from the differential, and first and second wheels mechanically coupled to the differential, each via one of the two shafts, respectively. A brake system is provided. In response to a difference between a target speed and an actual speed of the first wheel being greater than a predetermined threshold during braking of the wheels, the brake system is configured to (i) reduce a commanded braking capacity on the first wheel to increase the actual speed of the first wheel, and (ii) reduce a commanded rate of increase in braking capacity on the second wheel to reducing skidding associated with the wheels. According to at least one embodiment, the brake system is further configured to reduce the commanded rate of increase in the braking capacity on the second wheel at least until the actual speed of the first wheel is generally equal to the target speed. The brake system is further configured to increase the commanded braking capacity on the first wheel in response to the actual speed of the first wheel being generally equal to the target speed. The commanded braking capacity on the first wheel is increased to an amount less than a brake pressure limit at which slipping at the wheels occurs and wherein the brake pressure limit is at least partially defined by a load on the differential.

According to another embodiment, a braking system comprises first and second wheels, and a differential mechanically coupled to the wheels. At least one controller is programmed to command an increase in brake actuation force at the first wheel and, in response to a difference between a desired speed and an actual speed of the second wheel exceeding a threshold, reduce a rate of increase in brake actuation force at the first wheel. The at least one controller is further programmed to reduce the rate of the increase in the brake actuation force at the first wheel at least until an actual speed of the second wheel is generally equal to a commanded speed. The at least one controller is further programmed to increase commanded brake actuation force at the second wheel in response to an actual speed of the second wheel being generally equal to the commanded speed. The commanded brake actuation force at the second wheel increases towards a brake actuation force limit at which slipping at the second wheel occurs and wherein the brake actuation force limit is at least partially defined by a load on the differential.

According to another embodiment, a method of braking a vehicle is provided. The method first includes commanding an increase in brake pressure at a first wheel of the vehicle. In response to a difference between a target speed and an actual speed of a second wheel being greater than a predetermined threshold, the rate of the increase in brake pressure at the first wheel is reduced. The method further includes increasing the rate of the increase in brake pressure at the first wheel in response to the difference between the target speed and the actual speed of the second wheel being less than the predetermined threshold to reduce vibration within the vehicle.

### BRIEF DESCRIPTION OF THE DRAWINGS

FIG. 1 is a schematic diagram of one configuration of a hybrid electric vehicle;

FIGS. 2 through 5 are a flow charts illustrating various algorithms for controlling a brake system according to various embodiments;

FIG. 6A is a graph of wheel speed over time during a braking event in which a bang oscillation occurs as wheel speeds of two wheels are pulled-down and pulled-up simultaneously;

FIG. 6B is a graph of the brake pressure applied to the two wheels during the braking event illustrated in FIG. 6A;

FIG. 7A is a graph of wheel speed over time during an illustrative braking event in which a controller controls the braking of one wheel based on the speed of the other wheel to inhibit a bang oscillation event;

FIG. 7B is a graph of the brake pressure applied to the two wheels during the braking event illustrated in FIG. 7A;

FIG. 8A is a graph of wheel speed over time during an ABS braking event;

FIG. 8B is a graph of the brake pressure applied to the two wheels during the braking event illustrated in FIG. 8A; and

FIG. 8C is an enlarged portion of the graph of FIG. 8A illustrating the brake pressure over time in more detail.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Referring to FIG. 1, a hybrid electric vehicle (HEV) includes a power-split powertrain 10 in which either or both of an internal combustion engine 12 and a high voltage battery, or electric traction battery 14, provide tractive power to wheels 16 of the vehicle. The battery 14 has a two-way electrical connection, whereby it receives and stores electric energy (e.g., via regenerative braking) and also supplies the energy to an electric traction motor/generator 18, or “electric machine”.

In the power split powertrain 10, the engine 12 delivers power to a transmission 22 via a torque input shaft 26. The transmission 22 is contained in a powertrain casing 23 that is held to the vehicle body by powertrain mounts 24. The torque input shaft 26 is connected to a planetary gear set 28 through a one way clutch (not shown) or by direct connection. The planetary gear set 28 includes a ring gear 30, a sun gear 32, and a planetary carrier assembly 34. In one embodiment, the torque input shaft 26 is selectively connected to the carrier assembly 34 to power the planetary gear set 28; however, other configurations may include the torque input shaft 26 selectively connected to the ring gear 30 or sun gear 32. The sun gear 32 is driveably connected to a generator 38. The generator 38 may be selectively engaged with the sun gear 32 via a clutch (not shown) such that the generator 38 may selectively rotate with the sun gear 32 or not rotate with it. When the one way clutch (not shown) couples the engine 12 to the planetary gear set 28, the generator 38 generates energy as a reactionary element to the operation of the planetary gear set 28.

The battery 14, electric machine 18, and generator 38 are each interconnected in a two-way electric flow path through electrical connections 40. Electric energy generated from the generator 38 is transferred to the battery 14 through the electrical connections 40 and a high voltage bus where the energy is stored. The battery 14 also receives and stores electric energy through regenerative braking, in known fashion. This stored electric power can be used to work the electric machine 18 to propel the vehicle. The electric machine 18 can also receive power delivered from the engine 12 through the generator.

Torque and power transmitted either through the planetary gearset 28 or from the electric machine 18 is transferred through step ratio gears 42 comprising multiple meshing gear elements. The step ratio gears 42 react against the powertrain casing 23. The powertrain casing 23 is connected to the vehicle body via the powertrain mounts 24. The powertrain mounts 24 restrain the motion of the powertrain casing 23 through elastic and damping elements. The torque transmitted through the step ratio gears 42 spins a torque output shaft 44. Rotational power form the torque output shaft 44 is transferred to a differential 46. The differential 46 transmits torque and rotational energy to the wheels 16 via shafts 47, 48. The differential 46 also couples the behavior of shafts 47, 48 by a speed and torque equations below:

T_{left}=T_{right} (1)

Tᵢₙ+T_{left}+T_{right}=0 (2)

ω_{left}+ω_{right}=2*ωᵢₙ (3)

where T_{left} is the left side differential torque, T_{right} is the right side differential torque, Tᵢₙ is the torque input into the differential, ω_{left} is the speed of the left side of the differential, ω_{right} is the speed of the right side of the differential, and ωᵢₙ is the speed of the input of the differential.

Brake mechanisms or brakes 50 are provided on each of the wheels 16. The brakes 50 may be, for example, hydraulic brakes actuated by hydraulic pressure in a fluid circuit. The fluid circuit can include valves that are controlled to enable the delivery of hydraulic fluid to brake 50 to provide friction and pressure on the wheel 16, thus providing a braking force on the wheel 16. Other brake systems are contemplated, such as electromagnetic brakes. The terms “braking capacity,” “brake capacity,” and/or “braking actuation force” as subsequently used are intended to generally refer to the various types of contemplated forces applied to slow the wheels 16. The duration and amount of braking capacity utilized on each brake 50 can be separately controlled via controllers, as will be discussed.

The powertrain 10 described above is but one example of a powertrain suitable for a hybrid electric vehicle. Other powertrain configurations exist. For example, the powertrain may be a modular hybrid transmission (MHT) in which an output rod of an engine and an input rod of a motor/generator selectively engaged via a clutch such that either or both of the engine and motor/generator can provide torque to a transmission along one rotatable shaft. The powertrain may also be an electric-only powertrain without an internal combustion engine such that the vehicle is a battery electric vehicle (BEV). Other hybrid and BEV powertrains exist that are at least partially powered by an electric machine or tractive motor, and should therefore be considered within the scope of the present disclosure.

Given the descriptions of various structures of hybrid powertrains above, it should be understood that the vehicle can be propelled in a conventional mode, a hybrid mode, or an electric-only mode. In the conventional mode, the engine 12 provides tractive power to the wheels 16 without assist from the electric machine 18 and/or battery 14. In the hybrid mode, both the engine 12 and the electric machine 18 power the transmission to provide tractive force to the wheels 16. In the electric-only mode, the engine 12 is disabled and the electric machine 18 provides power through the transmission and to the wheels 16.

Various controllers 52, 54, 56, 58, 60 are provided that each have specific functions to control various aspects of the powertrain 10. A vehicle system controller (VSC) or powertrain control module (PCM) 52 oversees the operation of the powertrain 10 and coordinates commands to and between the other controllers 54, 56, 58, 60. A transmission control module (TCM) 54 controls the operation of the transmission in general. For example, the TCM 54 coordinates gear shifting and transitioning between the conventional mode of operation, the hybrid mode of operation, and the electric-only mode of operation. An engine control module (ECM) 56 controls the operation of the engine 12, and a battery electric control module (BECM) 58 controls the operation of the battery 14. A brake control module (BCM) 60 commands brake power to be applied to the brakes 50 on each of the wheels 16 in methods previously described.

While various separate controllers are illustrated, it should be understood that any configuration of control modules should be considered within the scope of the present disclosure. References to a “controller” or “at least one controller” hereinafter are intended to refer to at least one of the VSC/PCM 52, TCM 54, ECM 56, BECM 58 and BCM 60, or any combination thereof.

Conventional brake systems are known to include independently-controlled brakes at each wheel across a drive axle in a hybrid vehicle. In other words, the brake forces applied to one wheel are independent of the speed of the other wheel across the axle. When an operator of a vehicle depresses the brake pedal quickly to indicate a high brake demand, higher amounts of brake pressure are correspondingly quickly applied to the wheels of the vehicle. This causes wheel speed to sharply reduce. In an antilock brake system (ABS), for example, each wheel periodically exceeds its slip limit, causing the wheel speed of that wheel to drop as the wheel catches the ground. This is referred to as wheel pull-down. When one of the wheels is being pulled-down and the other wheel across the differential is not being pulled-down, there is a positive reaction torque on the non-pulled down wheel from the differential. Because of the speed relative to the threshold, the non-pulled-down wheel, more brake pressure is applied to that wheel to take on more torque. This in turn reduces the torque at the pulled-down wheel. This cycle can continue, with torque amounts and wheel speeds of each wheel across a differential oscillating back and forth. The fluctuating speed differences between the two wheels causes the half-shafts to wind and unwind with torque in an oscillating manner, and with a changing phase relative to the differential input speed. For powertrain configurations which have a large effective inertia connected to the input of a differential (e.g., a motor connected through a high gear ratio), the differential input shaft speed only partially resists these wheel speed fluctuations.

In a hybrid vehicle, this cycle of oscillating torques and wheel speeds from one wheel to the other during a braking event can load the transmission with back-torque. During the oscillating cycle, a bang may occur on the pull-down of a single wheel. This may be caused by the powertrain mounts exceeding motion limits of their elastic response, causing the powertrain mount to bottom-out. Once one wheel pulls-down, the controller works to adjust the braking of that wheel accordingly. If the wheel speeds and/or torques at both wheels across one differential align and are pulled-up or pulled-down simultaneously, undesirable vibrations or oscillations may be noticeable to occupants of the vehicle for a short amount of time if the magnitude of the pull-down or pull-up is relatively high. This occurrence may be referred to as a “bang oscillation”.

The present disclosure provides a coordinated control of the brakes 50 such that bang oscillation is reduced and/or eliminated. The controller 60 (or other controller) is programmed to detect an undesirable speed increase or decrease in at least one of the wheels 16 and provide a coordinated control of the braking across the differential 46 between both wheels 16 on one axle.

Referring to FIGS. 2-5, various methods or algorithms are illustrated that can be executed by at least one controller. The algorithms provide a method to inhibit the bang oscillation, as will be described. References are made to “wheel A” and “wheel B.” It should be understood that these designations are intended to refer to two different wheels 16 across one axle, separated by a differential 46. For example, “wheel A” may be one of the front left and front right wheel, while “wheel B” may be the other of the front left and front right wheel. In other words, the algorithms illustrated can be applied to either wheel 16 across a common differential 46.

In each of the algorithms illustrated in FIGS. 2-5, references are made to wheel speed, wheel torque, brake pressure, and the like. It should be understood that methods of determining these readings are known in the art. For example, various sensors may be placed on or about the wheels 16 that communicate to the controllers the relative speeds of the wheels 16 and braking capacity applied to the wheels 16 by the brakes 50. These determinations can be combined with sensed power distribution throughout the powertrain 10 in order to determine actual wheel torque, expected wheel torque, and expected wheel speeds, for example.

Referring to FIG. 2, a high-level method or algorithm 100 is illustrated to be executed by the controller 60 during a braking event according to one embodiment. At operation 102, the controller determines whether wheel A is being pulled-down. This can be determined by comparing an actual speed of a wheel 16 with an expected or commanded speed of the wheel 16. If the difference between the actual speed and the expected speed is not outside of a threshold range, there is no slip (wheel pull-down), and the method returns at operation 104 such that a continuous check for wheel slip or pull-down is provided. If, however, the difference is greater than a predetermined threshold (e.g., the wheel is spinning slower than it should be), wheel pull-down is indicated.

At this point, without implementing the control strategy described in the present disclosure, the beginnings of a bang oscillation event may occur as previously described, in which high torque amounts would be directed to wheel B because of the pull-down of wheel A. This would cause a reactionary high increase in braking capacity (e.g., brake pressure) at wheel B in response to a sharp increase in speed (pull-up) of wheel B. This cycle would possible repeat and oscillate between the wheels A and B, and as previously described a bang oscillation may occur if the wheel speeds of both wheels pull-down or pull-up simultaneously.

To inhibit the beginnings of a bang oscillation, a reduction of brake pressure or brake capacity is commanded at wheel A (i.e., the wheel being pulled-down) at operation 106 in response to the detected pull-down of wheel A. This eases the brake force at the pulled-down wheel, allowing the wheel speed to increase toward its expected speed. This may also increase the speed of wheel B as a reaction to the pull-down of wheel A. At operation 108, rather than increasing brake pressure at wheel B proportional to the speed of wheel B, the controller increases the brake pressure at wheel B at a controlled rate slower than a normal reactionary brake rate based upon the speed of wheel A.

The brake pressure applied to wheel B is reduced to a controlled rate based upon the speed of wheel A. As the magnitude of the speed of wheel A when compared to the expected wheel speed of A becomes smaller or larger, the rate of increase of brake pressure applied at wheel B can be reduced or increased accordingly. Additional details of this algorithm and control system will be described with reference to the remaining figures.

Referring to FIG. 3, another method or algorithm 200 is programmed to be executed by at least one controller. At operation 202, brakes 50 are actuated at wheels 16 in response to a depression of the brake pedal by the operator of the vehicle. At operation 204, the controller provides a continuous check to determine if wheel A is being pulled-down according to methods previously described. If no pull-down is occurring at wheel A, the method returns at operation 206 to continuously check for pull-down events.

At operation 208, in response to a detection of pull-down at wheel A, the controller commands a reduction of brake pressure or brake capacity applied to wheel A. This allows the speed of wheel A to return toward the expected or commanded speed of wheel A. At operation 210, a timer is started by the controller in response to the detection of the pull-down or reduction of brake pressure at wheel A. At operation 212, the controller determines whether any subsequent pull-down at wheel B has occurred. If a pull-down at wheel B has occurred while the time since the timer started at operation 210 is below a threshold (e.g., 0.2 seconds), the controller commands a controlled and coordinated braking between wheels A and B at operation 214. This controlled and coordinated braking can include reducing the rate of increase of brake pressure applied to wheel B in response to the speed of wheel A, as previously described with reference to the algorithm illustrated in FIG. 2. The controlled brake commands at wheel B in response to the wheel speed at wheel A during a braking event reduce the possibility of a bang oscillation.

Referring to FIG. 4, another method or algorithm 300 is programmed to be executed by at least one controller. At operation 202, the controller determines whether a brake signal is received, indicating a brake demand by the operator of the vehicle. If there is no brake signal received, the method returns at 304 to provide for a continuous check for a brake signal. At operation 306, brake pressure or brake capacity is applied and increased at a first rate of increase at wheels A and B across a common differential 46. This first rate of brake pressure increase is dependent on the amount of brake force demanded by the operator.

At operation 308, the controller provides for a continuous check as to whether the speed of wheel A has increased above its slip threshold and beings to pull-down. If wheel A is pulled-down, the controller outputs various commands at both wheel A and wheel B. It should be understood that the commands implemented at wheel A are illustrated on the left-hand side of the flowchart, while commands implemented at wheel B are illustrated on the right hand-side of the flowchart.

At operation 310, the brake pressure applied at wheel A at the time in which wheel A is pulled-down is recorded in a database or computer. This may be referred to as the “brake pressure limit” at wheel A, meaning the limit at which the brake pressure at wheel A causes a pull-down of wheel A. The brake pressure limit on each wheel may vary and may depend on the current loads provided on the differential 46 or the current tractive forces applied at the wheels. Generally simultaneous to operation 310, brake pressure is applied at wheel B at a second rate of increase in response to the pull-down of wheel A. The second rate is less than the first rate, and thus the brake pressure is applied at wheel B at a controlled, reduced rate than it normally would without implementing the algorithm 300.

At operation 314, the brake pressure at wheel A is reduced to allow the speed of the wheel to increase towards its expected or target speed. The brake pressure at wheel A is reduced until the difference between the rotational speed of wheel A (ω_{A}) and a target speed of wheel A (ω_{A}_{_{—}}_{target}) is less than a range or threshold. In other words, the brake pressure at wheel A is reduced until the speed of wheel A is within a threshold of its expected or target speed.

Even with the controlled brake pressure applied at wheel B, pull-down of wheel B may still occur because of the speed changes of wheel A. If the controller determines that a pull-down of wheel B has occurred, the brake pressure applied at wheel B at the time in which wheel B is pulled-down. Similar to wheel A, this may be referred to as the “pressure limit at wheel B” in which slip occurs. Subsequent to the pull-down at wheel B, the brake pressure at wheel A is commanded to increase at a controlled rate toward (but not to exceed) the brake pressure limit of wheel A. This is in reaction to the pull-down of wheel B, such that sufficient brake pressure is sent to the wheels to fulfill the demands of the driver and slow the speed of the vehicle. The method repeats at operation 320, such that the controller commands the brake pressures and brake pressure rates at wheels A and B based on relative speeds of the opposite wheel across the differential 46. During subsequent controls of the brake pressure, the controller works to not exceed the recorded brake pressure limits of each wheel simultaneously in order to inhibit the simulations pull-down of the wheels and a potential bang oscillation event.

Referring to FIG. 5, a method or algorithm 400 is programmed to be executed by at least one controller in which two sets of timers are used for respective wheels. During a braking event, at operation 402 a pull-down is detected at wheel A according to methods previously described. The brake pressure applied at wheel A at the time of the pull-down is recorded in a computer or database at operation 404, according to embodiments previously described. A first timer (Timer₁) is started upon the pull-down of wheel A. At operation 408, as described in previous embodiments, the brake pressure at wheel A is reduced to enable the speed of wheel A to increase towards its target speed.

Subsequent to the reduction of brake pressure at wheel A, a determination is made at operation 410 as to whether wheel B pulls down while Timer₁ is below a predetermined threshold (e.g., 0.1-0.5 seconds). If there is no pull-down of wheel B or if Timer₁ exceeds the time threshold, Timer₁ is reset at operation 412 and the algorithm returns at operation 414. This process continues until a pull-down of wheel B is detected within the threshold time after a pull-down of wheel A.

Once a YES is determined at operation 410, the brake pressure limit at wheel B is recorded, similar to embodiments previously described. Upon the detected pull-down of wheel B, a second timer (Timer₂) is started at operation 418, and the brake pressure at wheel B is reduced to enable the speed of wheel B to increase towards its target speed at operation 420 similar to embodiments previously described.

Subsequent to the reduction of brake pressure at wheel B, and similar to operation 410, at operation 422 the controller determines whether wheel A has pulled-down while Timer₂ is below a second predetermined threshold (e.g., 0.1-0.5 seconds). If wheel B has pulled-down and if Timer₂ has exceeded the time threshold, the algorithm returns to operation 404 in which the brake pressure limit is again recorded. This repeating process continues until neither wheel on either side of a drive axle is pulled-down during the braking event.

If a NO is determined at operation 422, then the controller determines whether a pull-down at wheel B is occurring while Timer₂ is below the second predetermined threshold. If wheel B is not being pulled down or if Timer₂ exceeds the second threshold, the method returns at operation 426 due to neither wheel pulling-down. However, if a pull-down at wheel B is determined and Timer₂ is less than the second threshold, the method returns to operation 416 in which the brake pressure limit at wheel B is recorded. Upon the return to operation 416, Timer₂ may optionally be reset.

Referring to FIGS. 6-7, various graphs are provided to compare the effect of programming at least one controller with the exemplified algorithms of FIGS. 2-5. FIGS. 6A-6B illustrate an embodiment in which the controller is not configured to inhibit bang oscillation and thus bang oscillation occurs, given the proper circumstances. In comparison, FIGS. 7A-7B illustrate an embodiment in which a control algorithm is implemented in the controller to control brake pressure applied at each wheel based on the relative speeds of the other wheel across the differential 46.

Referring to FIG. 6A, the wheel speed of the front left (FL) and front right (FR) wheels are illustrated, for example, during a braking event in which bang oscillation occurs. FIG. 6B corresponds to FIG. 6A, and indicates the brake pressures applied to the FL wheel and FR wheel based on a braking event commanded by the operator of the vehicle.

Between t=3.8 seconds (s) and t=4.0 s, brake pressure in each of the FL and FR wheels is steadily increasing, thus reducing the rotational wheel speed of the wheels.

Shortly before t=4.0 s, the slip limit of the FR wheel has been reached, and the speed of the FR wheel decreases as the FR wheel begins to pull-down. In response to the FR wheel being pulled-down, the brake pressure is quickly reduced on the FR wheel, allowing the speed of the FR wheel to increase.

Because of the change of torque between the FR and FL wheels, the slip limit of the FL wheel is subsequently reached shortly before t=4.1 s. The speed of the FL wheel therefore decreases and the FL wheel is pulled-down. This oscillating of relative wheel speeds and brake pressure is continued until about t=4.25 s, at which time the two wheel speeds align and pull-down together. This creates a bang oscillation, as previously described. The aligned oscillations can continue for over a second, until the oscillating effects dissipate as the relative torque at the wheels levels off and neither wheel is being pulled-down.

In contrast to FIGS. 6A-6B, FIGS. 7A-7B illustrate an illustrative example in which the wheel speeds and brake pressures applied to the FL and FR wheels in an exemplary braking event controlled with a controller implementing at least one of the various embodiments described herein to inhibit a bang oscillation.

Referring to FIGS. 7A-7B, between t=3.8 s and t=4.0 s, brake pressure in each of the FL and FR wheels is increasing at a steady first rate due to braking demands provided by the operator of the vehicle. This reduces the rotational wheel speed of each wheel.

Shortly before t=4.0 s, the slip limit of the FR wheel has been reached, and the speed of the FR wheel decreases as the FR wheel is pulled-down. The brake pressure is reduced on the FR wheel, allowing the FR wheel to return to its target speed. At this time, the FL wheel begins to pull-down. Based on the speed of the FL wheel being outside of a predetermined threshold range, the application of the brakes applied on the FR wheel is increased at a slower, controlled second rate less than the first rate. This controlled steady application of brake pressure to the FR wheel reduces the impact of any subsequent pull-down of the FL wheel. This process continues throughout the braking event to inhibit a bang oscillation. As indicated in FIG. 7A, the wheel speeds of the FL and FR wheel do not pull-down simultaneously, due to the controlled increase of brake pressure at one wheel when the other wheel across the differential is pulled-down.

Referring to FIGS. 8A-8C, another embodiment of the control of the two wheels across a common differential is illustrated. In this embodiment, the pull-down thresholds, or slip thresholds, are illustrated over time in relation to the brake pressures of each of wheels A and B during application of the brakes at the wheels.

Referring to FIG. 8A, a situation is illustrated, for example during an ABS braking event, in which the speeds of the wheels A and B oscillate after wheel A is originally pulled-down. Pursuant to methods described herein, brake actuation at wheel B is undergone in response to the drop in speed at wheel A. Similar to embodiments previously illustrated, the brake pressure at each wheel is illustrated in FIG. 8B. FIG. 8C shows a more detailed view of the varying brake pressures at wheels A and B during the braking event, in relation to the slip thresholds.

Referring to FIG. 8C, sections 1-16 are separated and the braking forces taken during these sections will be individually described.

In section 1, the brake pressures to both wheel A and wheel B are increased at a rate R₊₁.

In section 2, excessive slip or wheel pull-down is detected at wheel A. The brake pressure which caused wheel A to pull-down is recorded as P_{A}. The controller subsequently commands the pressure at wheel A to decrease at a rate R₋₁. Generally simultaneously, the controller reduces the rate of increase for the brake pressure at wheel B to a rate R₊₂ that is less than R₊₁.

In section 3, the speed of wheel A begins to recover. The controller commands the brake pressure applied to wheel A to be held approximately constant to allow wheel A to fully recover.

In section 4, wheel A has fully recovered from the pull-down event. The speed of wheel A has increased to a desired speed after the reduction of brake pressure at wheel A. The controller therefore commands a brake pressure to increase at a rate of approximately R₊₁ (e.g., a rate similar to the original rate of increase of brake pressure.)

In section 5, wheel B begins to pull-down excessively, similar to the pull-down of wheel A. The brake pressure which caused wheel B to pull-down is recorded as P_{B}. In response to the pull-down of wheel B, the controller commands the applied brake pressure at wheel B to decrease to a rate R₋₁. Thereafter, the peak negative torque that will be transferred through the differential is estimated according to above-referenced methods. At this time, the brake pressure limit or slip limit for wheel A is updated based upon the estimated torque transferred through the differential. The controller commands the brake pressure for wheel A to decrease to a rate R₊₃, a rate less than R₊₁, to inhibit wheel A from pulling-down before wheel B fully recovers.

In section 6, wheel B begins to recover and level off. The controller commands the brake pressure at wheel B to be held generally constant to allow the speed of wheel B to recover towards its commanded speed.

In section 7, wheel B has fully recovered from the pull-down event. The time until the next wheel pull-down event of wheel A is estimated based on the history of the difference between previous pull-downs of wheels A and B, among other factors. At generally simultaneous moments, the brake pressure increase rate is increased to a rate R₊₄ for wheel A and R₊₆ for wheel B. These pressures will be combined with R₊₅ and R₊₇, respectively, as will further be discussed, and the combined rates of pressure increases will be optimized to ensure that wheel A and wheel B do not pull-down or pull-up at the same time.

At section 8, wheel A begins to near its brake pressure limit or threshold P_{A}. As the brake pressure of wheel A approaches the threshold P_{A}, the brake pressure rise rate for wheel A is decreased to a rate R₊₅ that is less than R₊₄, and the brake pressure rise rate for wheel B is decreased to a rate R₊₇ that is less than R₊₆.

In section 9, wheel A begins to slip excessively. The brake pressure which caused wheel A to pull-down is used to update the pressure limit PA and PB according to methods previously described. The brake pressure applied to wheel A is commanded to decrease at a rate R−1, and the peak negative torque that will be transferred through the differential is estimated. The brake pressure limit for wheel B is updated based upon the estimated torque that will be transferred through the differential. The time until the next wheel pull-down event is estimated for wheel B based on the history of timings between previous wheel pull-downs. If wheel B is estimated to pull-down before wheel A fully recovers, then the brake pressure rate applied to wheel B is adjusted and is reduced accordingly. In the embodiments illustrated in FIG. 8C, no pressure adjustment is needed. However, a reduction in brake pressure rate would be necessary if the brake pressure of wheel B was projected to intersect with the brake pressure limit of wheel B.

This process of adjusting the pressures to wheels A and B is repeated at least until the pull-down of the wheels is eliminated, or until the braking commanded to the wheels has ceased. By controlling the brake pressures at each wheel based on the speeds of the other wheel along the differential, and projecting the time in which a subsequent pull-down will happen based on the intermittent timing between pull-downs, the bang oscillation is inhibited to improve the drivability of the vehicle. As previously described, it should be understood that references made to brake “pressure” are intended to encompass other braking mechanisms, and the broader aforementioned term of “brake actuation force” can be substituted for “brake pressure” to encompass other forms of providing braking forces to the wheels.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A vehicle comprising:
a differential;
shafts;
first and second wheels mechanically coupled to the differential via the shafts; and
a brake system configured to, in response to a difference between a target speed and an actual speed of the first wheel being greater than a predetermined threshold during braking of the wheels, (i) reduce a commanded braking capacity on the first wheel to increase the actual speed of the first wheel and (ii) reduce a commanded rate of increase in braking capacity on the second wheel to reduce skidding associated with the wheels.

2. The vehicle of claim 1, wherein the brake system is further configured to reduce the commanded rate of increase in the braking capacity on the second wheel at least until the actual speed of the first wheel is generally equal to the target speed.

3. The vehicle of claim 1, wherein the brake system is further configured to increase the commanded braking capacity on the first wheel in response to the actual speed of the first wheel being generally equal to the target speed.

4. The vehicle of claim 3, wherein the commanded braking capacity on the first wheel is increased to an amount less than a brake pressure limit at which slipping at the wheels occurs and wherein the brake pressure limit is at least partially defined by a load on the differential.

5. The vehicle of claim 4, wherein the brake pressure limit is further at least partially defined by a tractive force transmitted by the first wheel when the difference between the target speed and the actual speed of the first wheel is greater than the predetermined threshold.

6. The vehicle of claim 5, wherein the brake system is further configured to, after reducing the commanded braking capacity on the first wheel, increase a commanded braking capacity on the first wheel at another rate less than the rate.

7. The vehicle of claim 1, wherein the commanded braking capacity on the second wheel is increased to a value less than a variable brake pressure limit at which slipping at the wheels previously occurred, and wherein the brake pressure limit is at least partially defined by a load on the differential.

8. The vehicle of claim 7, wherein the brake pressure limit is further at least partially defined by a tractive force transmitted by the first wheel when the difference between the target speed and the actual speed of the first wheel is greater than the predetermined threshold.

9. A braking system comprising:
first and second wheels;
a differential mechanically coupled to the wheels; and
at least one controller programmed to (i) command an increase in brake actuation force at the first wheel, and (ii) in response to a difference between a desired speed and an actual speed of the second wheel exceeding a threshold, reduce a rate of the increase in brake actuation force at the first wheel.

10. The braking system of claim 9, wherein the at least one controller is further programmed to reduce the rate of the increase in the brake actuation force at the first wheel at least until an actual speed of the second wheel is generally equal to a commanded speed.

11. The braking system of claim 10, wherein the at least one controller is further programmed to increase commanded brake actuation force at the second wheel in response to an actual speed of the second wheel being generally equal to the commanded speed.

12. The braking system of claim 11, wherein the commanded brake actuation force at the second wheel increases towards a brake actuation force limit at which slipping at the second wheel occurs and wherein the brake actuation force limit is at least partially defined by a load on the differential.

13. The braking system of claim 9, wherein the at least one controller is further programmed to, after reducing the rate of the increase in brake actuation force at the first wheel, reduce the rate of increase in brake actuation force at the second wheel.

14. The braking system of claim 9, wherein the commanded brake actuation force at the first wheel increases to an actuation force less than a brake actuation force limit at which slipping at the first wheel occurs and wherein the brake actuation force limit is at least partially defined by a load on the differential.

15. The braking system of claim 14, wherein the brake actuation force limit is at least partially defined by a tractive force transmitted by the second wheel when the difference between the desired speed and the actual speed of the second wheel is greater than the threshold.

16. A method of braking a vehicle comprising:
commanding an increase in brake pressure at a first wheel; and
reducing a rate of the increase in brake pressure at the first wheel in response to a difference between a target speed and an actual speed of a second wheel being greater than a predetermined threshold.

17. The method of claim 16 further comprising increasing the rate of the increase in brake pressure at the first wheel in response to the difference between the target speed and the actual speed of the second wheel being less than the predetermined threshold to reduce vibration within the vehicle.

18. The method of claim 16 further comprising, after reducing the rate of increase in brake pressure at the first wheel, commanding an increase in the brake pressure at the first wheel toward a brake pressure limit, wherein the brake pressure limit is variably defined by a brake pressure value at the first wheel when a previous slip occurs.
